(19) United States
(12) Patent Application Publication
(10) Pub. No.: US 2004/0155746 A1
(43) Pub. Date: Aug. 12, 2004

(54) Fixing member

(76) Inventor: Sebastian Gudmundson, Sunnansjo (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/481,035

(22) PCT Filed: May 31, 2002
(86) PCT No.: PCT/SE02/01049

(30) Foreign Application Priority Data
Jun. 18, 2001 (SE) 0102143-5

(51) Int. Cl. H01F 27/29

(52) U.S. Cl. 336/192

(57) ABSTRACT

A device for absorbing axial and radial short-circuit forces in a cable-wound inductor where a fixing member (10) with its inner envelope surface surrounds the cable winding (4) of the inductor.

### TECHNICAL FIELD

The present invention relates to a device for absorbing short-circuit forces in an inductor comprising at least one cable winding. In this context, cable winding means a winding constituted by a cable, in which the cable consists of an electric conductor that is surrounded by a solid, continuous insulating material.

### BACKGROUND ART

Using inductors in electric power systems for transmission of electrical energy is known. Electric power systems in this connection mean systems for voltages exceeding 1 kilo-volt and inductors mean stationary induction machines such as reactors and transformers.

When an inductor is short-circuited, the cable winding of the inductor is subjected to axial and radial short-circuit forces. The radial forces in the inductor act outwards and bring about tensile stresses on the cable that constitutes the winding in the inductor. The axial forces in the inductor act upwards/downwards and bring about shearing stresses on the cable. When the inductor is short-circuited, both these types of mechanical stresses may lead to the cable being damaged. To avoid this, it is desirable, in cable-wound induction machines such as reactors and transformers, to protect the cable winding, for example by clamping the winding or minimizing the short-circuit forces.

WO 98/34243 describes a cable-wound transformer/reactor, where the winding is provided with a number of axially extending spacers, which separate each cable turn in a radial direction in the winding, in order, inter alia, to create axial cylindrical cooling ducts. Further, the spacer according to the embodiment is adapted to axially clamp the winding together into a uniform winding subassembly.

However, WO 98/34243 is limited to primarily absorbing short-circuit forces acting in the axial direction since no prestress in the radial direction occurs.

WO 99/28923 describes a cable-wound transformer with one high-voltage winding and one low-voltage winding. Here the turns of the high-voltage winding alternate with the turns of the low-voltage winding, in order thus to minimize the short-circuit forces. However, for reactors with one winding only, this method is not applicable.

### SUMMARY OF THE INVENTION

The object of the present invention is to secure a cylinder-shaped cable winding in an inductor comprising cable. By means of the invention, this is achieved with the aid of a fixing member, whereby the above-mentioned disadvantages and problems are completely or partially overcome. It is another object to describe a method for mounting the fixing member on the cable winding.

The fixing member according to the invention is characterized in that it has the shape of a thin-walled cylinder with an inner and an outer envelope surface, the inner envelope surface surrounding the outside of the cable winding. Because the fixing member surrounds and clamps the cable winding, the cable is fixed in the winding and is thus prevented from being mechanically damaged by the short-circuit forces to which the cable is subjected during a short-circuit. The short-circuit forces acting in the radial and axial directions are absorbed by the friction between the cable and the fixing member and by the stiffness in the fixing member.

### BRIEF DESCRIPTION OF THE DRAWINGS

The invention will be described in greater detail in the following with reference to the accompanying drawings, wherein

FIG. 1 shows parts of a cable-wound inductor in the form of a single-phase reactor with a lower winding plate,

FIG. 2a shows a top view of a fixing member with an upper winding plate and brackets,

FIG. 2b shows a side view of a fixing member with an upper winding plate and brackets.

### DESCRIPTION OF THE PREFERRED EMBODIMENTS

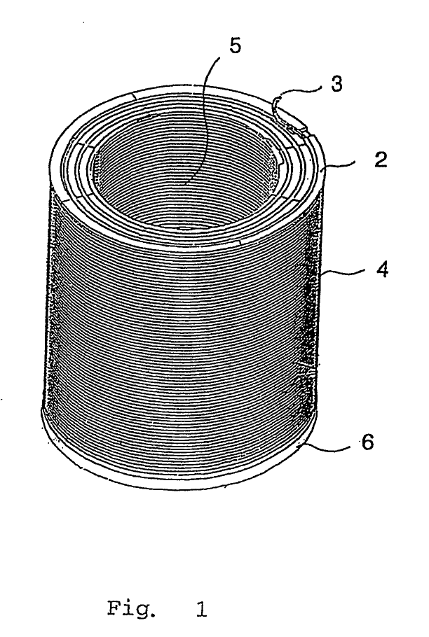

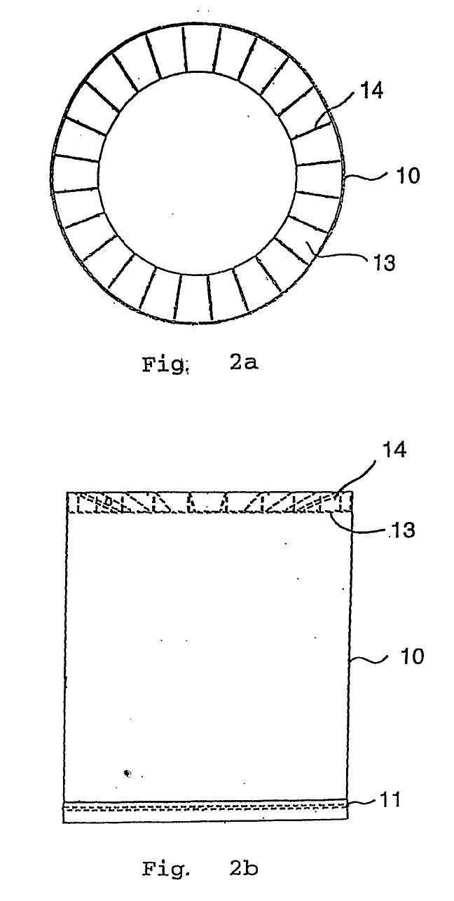

FIG. 1 shows parts of a cable-wound inductor in the form of a single-phase reactor. The reactor is intended for connection in series with a line in an electric power system (not shown) to limit the magnitude of fault currents. The reactor comprises a supporting structure 2 supporting a cable 3 that is wound so as to form a cylinder-shaped cable winding 4, which surrounds an air-filled centre portion 5 forming the air core of the reactor. The cable 3 is adapted to carry an electric current to generate a magnetic flux in the air core 5. The winding 4 is wound on top of a lower winding plate 6 of glass fibre-reinforced epoxy. On the lower winding plate there is a crescent-shaped slot (not shown) arranged around the envelope surface of the lower winding plate. In addition, four axially directed crescent-shaped slots (not shown) are arranged on the lower winding plate. FIG. 2 shows a fixing member 10 of glass fibre-reinforced epoxy, which is intended to be mounted around the winding 4. In the upper part of the fixing member 10, on the inner envelope surface thereof, an upper winding plate 13 of glass fibre-reinforces epoxy is arranged. On its upper side, 24 brackets 14 of glass fibre-reinforced epoxy are arranged. Corresponding brackets 14 are arranged in the same way on the underside of the lower winding plate 6 (not shown). Near the lower part of the fixing member 10, a crescent-shaped slot 11 is arranged around the envelope surface of the fixing member, and in the lower edge of the fixing member, four axially directed crescent-shaped slots are arranged (not shown).

Before the fixing member 10 is mounted across the winding 4, it is heated so that its diameter expands. When a sufficient diameter of the fixing member has been attained, the fixing member is fitted over the winding. The four crescent-shaped slots on the fixing member 10, together with the four crescent-shaped slots on the lower winding plate 6, form circular slots (not shown). In the four circular slots, four locking pins (not shown) are arranged, which prevent the fixing member from moving in the radial direction. Together with the crescent slots of the lower winding plate 6, the crescent slot 11 forms a circular slot that, together with a locking rod (not shown), prevents the fixing member from moving in the axial direction. When the fixing member has cooled from the heating, its diameter shrinks and tightens around the winding 4 that is now fixed and prestressed in the radial direction by the fixing member.

The strength in the fixing member 10 and the friction between the cable 3 and the fixing member 10 support the forces that arise during a short-circuit and hence prevent the cable 3 from being mechanically damaged by the stresses formed in the cable 3. In addition to the fixing member, also the lower winding plate 6 with brackets and the upper winding plate 13 with brackets 14 assist in absorbing short-circuit forces acting in the axial direction.

The principle of the invention has been described above on the basis of a cable-wound single-phase reactor with an air core. However, it is realized that the invention is also applicable to other types of cable-wound inductors, for example to cable-wound transformers with an iron core.

1. A device for absorbing short-circuit forces in a cable-wound inductor (1), characterized in that a fixing member (10) with its inner envelope surface surrounds the cylinder-shaped cable winding (4) of the inductor on the outer side thereof.

2. A device according to claim 1, characterized in that the fixing member (10) at is lower end is provided with a lower winding plate (6) and at its upper end with an upper winding plate (13).

3. A device according to claims 1-2, characterized in that those sides of the winding plates (6, 13) that are facing away from the fixing member are both provided with brackets (14).

4. A device according to any of claims 1-3, characterized in that the fixing member (10), the winding plates (6, 13) and the brackets (14) are made of glass fibre-reinforced epoxy.

5. A method for mounting a device according to claim 1, characterized in that the fixing member (10) is heated prior to mounting such that the diameter of the fixing member increases before it is fitted over the cable winding (4).

6. An inductor with a cylinder-shaped cable winding comprising a device for absorbing short-circuit forces, characterized in that the device is in the form of a fixing member (10) surrounding the cable winding of the inductor on the outer side thereof.

7. An inductor according to claim 6, characterized in that the inductor comprises an air core.
